(19) United States
(12) Patent Application Publication
(10) Pub. No.: US 2019/0334845 A1
(43) Pub. Date: Oct. 31, 2019

(54) MESSAGING INTERFACE CONFIGURED TO A RENDER GRAPHICAL SENTIMENT AND PROGRESSION INDICATOR

(71) Applicant: SLACK TECHNOLOGIES, INC., San Francisco, CA (US)

(72) Inventor: Felix Rieseberg, San Francisco, CA (US)

(21) Appl. No.: 15/962,388

(22) Filed: Apr. 25, 2018

(51) Int. Cl. H04L 12/58; G06F 3/0481; G06F 3/0482; G06F 17/28

(52) U.S. Cl. CPC H04L 51/06; G06F 17/289; G06F 3/0482; G06F 3/04817

(57) ABSTRACT

Methods, apparatuses, and computer program product are described herein that are configured to transform an input sequence into a message format that can be expressed in a graphical sentiment and progression indicator to a messaging interface. For example, the methods, apparatuses, and computer program product may be configured to receive an input sequence comprising code points and a syntax element. Further embodiments of the methods, apparatuses, and computer program product comprise transforming the input sequence into a message format that is configured for rendering, by a messaging application, a graphical sentiment and progression indicator to a messaging interface of the messaging application, wherein the graphical sentiment and progression indicator is rendered based on the code points and the syntax element of the input sequence.

### BACKGROUND

Emojis and emoticons are pictorial representations of everyday aspects of life and have become a form for international language that add tone and clarity to electronic communications between users. Emojis and emoticons can be used in a number of ways to communicate when words fail, to lighten the mood of a message, or to express individuality. Applicant has identified a number of deficiencies associated with creating and rendering emojis and emoticons to messaging interfaces of conventional messaging platforms. Through applied effort, ingenuity, and innovation, many of these identified problems have been solved by developing the solutions that are embodied by the invention described below.

### BRIEF SUMMARY

In general, embodiments of the present invention provided herein include methods, apparatus, and computer program products for creating customizable graphical sentiments and progression indicators for messaging.

Methods, apparatuses, and computer program product are described herein that are configured to transform an input sequence into a message format that can be expressed in a graphical sentiment and progression indicator to a messaging interface. For example, the methods, apparatuses, and computer program product may be configured to receive an input sequence comprising code points and a syntax element. Further embodiments of the methods, apparatuses, and computer program product comprise transforming the input sequence into a message format that is configured for rendering, by a messaging application, a graphical sentiment and progression indicator to a messaging interface of the messaging application, wherein the graphical sentiment and progression indicator is rendered based on the code points and the syntax element of the input sequence. In an example embodiment, methods, apparatuses, and computer program product are configured for rendering the graphical sentiment and progression comprising a start point, a progress point, and an end point, wherein the progress point is configured to progress from the start point that indicates a beginning of a task to the end point that indicates an end of the task, whereby the progress of the progress point from the start point to the end point graphically indicates a percentage measurement of the task completed. Furthermore, methods, apparatuses, and computer program product are configured to animate the progress point such that the progress point appears to move from the start point towards the end point.

### BRIEF DESCRIPTION OF THE FIGURES

Reference will now be made to the accompanying drawings, which are not necessarily drawn to scale, and wherein:

FIG. 1 illustrates an example messaging system configured in accordance with some embodiments discussed herein;

FIG. 2 illustrates a schematic block diagram of an example rendering apparatus that is configured to transform an input sequence into a message format that is configured for rendering a graphical sentiment and progression indicator to a messaging interface in accordance with some embodiments discussed herein;

FIG. 3 illustrates a schematic block diagram of an example network application server that is configured to identify one or more client devices associated with a group-based communication channel in accordance with some embodiments discussed herein;

FIG. 4 is an example sequence diagram which depicts a client device receiving transformed data to render a graphical sentiment and progression indicator in accordance with some embodiments discussed herein;

FIGS. 5, 6, and 7 illustrate various elements of example messaging interfaces having messaging communications in accordance with some embodiments discussed herein; and

FIG. 8 illustrates a flow diagram of example operational steps of an example apparatus that is configured to transform an input sequence into a message format that is configured for rendering a graphical sentiment and progression indicator for outputting to a messaging interface in accordance with some embodiments discussed herein.

### DETAILED DESCRIPTION

Some embodiments of the present invention will now be described more fully hereinafter with reference to the accompanying drawings, in which some, but not all embodiments of the inventions are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

### Terms

As used herein, the terms “data,” “content,” “digital content,” “digital content object,” “information,” and similar terms may be used interchangeably to refer to data capable of being transmitted, received, and/or stored in accordance with embodiments of the present invention. Thus, use of any such terms should not be taken to limit the spirit and scope of embodiments of the present invention. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be sent directly to another computing device or may be sent indirectly via one or more intermediary computing devices, such as, for example, one or more servers, relays, routers, network access points, base stations, hosts, and/or the like.

The term “graphical sentiment and progression indicator” refers to an emotive interface rendered graphic that visualizes and conveys the progression of a task such as the progress of a driver to a destination. The graphical sentiment and progression indicator is rendered based on code points and a syntax element of an input sequence (each defined below). In another example embodiment, the graphical sentiment and progression indicator is rendered based on an emoji component (defined below) and the syntax element of the input sequence.

In some example embodiments, the graphical sentiment and progression indicator may comprise the following components: an emoji component and a status indicator component (defined below). The graphical sentiment and progression indicator provides immediate feedback on a task and conveys current progress of the task, how much has already been accomplished, and how much is left in the task. For example, the graphical sentiment and progress indicator may include a rendered graphic (e.g., progress bar that changes in size in accordance with the proportion of a task completed or a car emoji that moves from a start point to an end point to indicate current position). In yet another example, the graphical sentiment and progression indicator may include a rendered animated graphic, wherein, for example, the car emoji appears to move across the route trajectory from the start point to end at the current position.

The term “input sequence” refers to a sequence of characters recognized and transformed by a messaging application to render a graphical sentiment and progression indicator in a message by a messaging interface. The input sequence comprises code points (defined below) and a syntax element (defined below). In another embodiment, the input sequence comprises an emoji component and the syntax element.

The term “syntax element” refers to special command characters found within an input sequence that indicate that a graphical sentiment and progression indicator be rendered. The use of special command characters indicate the type of graphical sentiment and progression indicator be rendered (e.g., progress bar that changes in size in accord with the proportion of a task completed or a car emoji progress indicator that moves from a start point to an end point to indicate current position). In one embodiment, the types may be indicated by the syntax element (e.g., “:bar”: progress bar; “90%”: emoji progress indicator). The messaging application analyzes the input sequence using syntax-directed translations to identify the special command characters to indicate generation of a graphical sentiment and progression indicator in a message format (defined below) for rendering by a messaging application to a messaging interface of the messaging application.

The term “status indicator component” comprises status indicator objects used to convey a quick status of a task. In generating a status indicator component to be rendered to a messaging interface, such as a progress bar element, a traffic light element, a tachometer element, an infographic element, a pie bar element, an hourglass element, or a timer element, the messaging application calls to the status indicator object structure (defined below) to create a status indicator object (defined below). For example, a call by the messaging application for a progress bar element. A call to a status indicator object is based on the syntax element in the input sequence (e.g., “:bar”). A messaging application analyzes the syntax element using syntax-directed translations to identify special command characters used to call for the desired status indicator object. In one embodiment, the status indicator object may be indicated by syntax element (e.g., “:bar”: progress bar element; “:traffic”: traffic light element; “:tacho”: tachometer element; “:infograph”: infographic element; “:pie”: pie bar element; “:hourglass”: hourglass element; “:timer”: timer element).

The term “status indicator object structure” refers to an abstract base class that defines functions that are overridden by status indicator object subclasses. The status indicator object structure is, in an example embodiment, a shared library within a messaging application server that is implemented using any object oriented programming language. The status indicator object structure provides status indicator objects. Examples of the function performed common to all the status indicator objects include, but are not limited to creating, initializing, and updating a status indicator component.

The term “emoji component” comprises any of various graphical expressions, including emojis, emoticons, small images, symbols, glyphs, or icons used in a messaging interface to express an emotional attitude, a sentiment, to convey information succinctly, and/or communicate a message playfully without using words. The emoji component may be added to the input sequence by selecting from a plurality of emojis or emoticons displayed as a virtual keyboard on a display screen (i.e., an emoji component menu) on a messaging interface of a messaging application, inputting the standard emoji code or code point in the input sequence via a messaging interface of a messaging application.

The term “message format” refers to an input sequence, or data extracted from an input sequence, that is transformed or otherwise packaged by a messaging application in a format that can be rendered by a messaging application. In one example, the messaging application converts Unicode emoji code points into images using JPEG (Joint Photographic Experts Group), GIF (Graphics Interchange Format), or PNG (Portable Network Graphics) standards. The message format in which a JPEG, GIF, or PNG files are attached to a message provides for any messaging application to render the graphical sentiment and progression indicator to a messaging interface, regardless of the type of client device, operating system, or messaging application.

The term “messaging application” refers to a computer program that is configured to run on a mobile device, on a desktop device, and/or in web browser sessions and configuring for rendering graphical user interfaces for displaying messages. In one example, the messaging application may be embodied as a messaging application server configured to receive electronic data from one or more client devices via a communication network. For example the messaging application server may be operable to receive and process messages provided by the one or more client devices. The messaging application server may also facilitate the display of messages to the one or more client devices. In an example embodiment, the messaging application server parses the code points and the syntax element in the input sequence to render the graphical sentiment and progression indicator to a messaging interface of a messaging application.

The term “code points” refers to units of a character coded set. A coded character set is a set of characters for which a unique number has been assigned. A code point value represents the position of a character in the coded character set which is given meaning by the Unicode standard. Accordingly and for example, the code point for an elephant emoji is “U+1F418.” A messaging application may render an emoji component based on the code points in a input sequence by a messaging interface. The code points may include non-printing code points, such as a joiner Unicode character used to combine emojis to produce a new glyph and/or a direction Unicode character used to enforce a direction of an emoji component or a status indicator component.

The term “messaging interface” refers to a virtual communications environment or feed that is configured to display messaging communications posted and viewable by users. The format of emojis or emoticons may appear differently or not at all on different operating systems; however, the messaging application may replace any instance of a graphical sentiment and progression indicator so as to render compatibly with any operating system of a messaging application. One example of a messaging interface is a group-based communication interface (defined below).

The term “progress awareness indicator” refers to an emoji or emoticon used to indicate movement of a person or object. For example, a gust of air emoji used in combination with a car emoji expresses a fast moving car. The message format that is configured for rendering the graphical sentiment and progression indicator may comprise the progress awareness indicator rendered proximate to the emoji component such that, when rendered in combination, indicates motion.

The term “user” should be understood to refer to an individual, a group of individuals, business, organization, and the like. Users may access a group-based communication or messaging system using client devices. “Group-based” is used herein to refer to a system, channel, message, or virtual environment that has security sufficient such that it is accessible only to a defined group of users. The group may be defined by common access credentials such as those of an organization or commercial enterprise. Access may further be facilitated by a validated request to join or an invitation to join transmitted by one group member user to another non-member user. Group identifiers are used to associate data, information, messages, etc., with specific groups.

The terms “user profile,” “user account,” and “user account details” refer to information associated with a user, including, for example, a user identifier, one or more group-based communication channel identifiers associated with group-based communication channels (defined below) that the user has been granted access to, one or more group identifiers for groups with which the user is associated, an indication as to whether the user is an owner of any group-based communication channels, an indication as to whether the user has any group-based communication channel restrictions, a plurality of messages, a plurality of emojis, a plurality of conversations, a plurality of conversation topics, an avatar, an email address, a real name (e.g., John Doe), a username (e.g., j doe), a password, a real name, a time zone, a status, and the like. The user account details can include a subset designation of user credentials, such as, for example, login information for the user including the user's username and password.

The term “client device” refers to computer hardware(s) and/or software(s) that is/are configured to access one or more services made available by one or more messaging application servers. The messaging application server(s) is/are often (but not always) on another computer system, in which case the client device accesses the service by way of a network. A client device may be associated with a group identification, where the group identification is an electronic indication that suggests a group (e.g. user group) that the user belongs to. Client devices may include, without limitation, smart phones, tablet computers, laptop computers, desktop computers, wearable devices, personal computers, enterprise computers, and the like.

The term “group-based communication channel” refers to a virtual communications environment or feed that is configured to display messaging communications posted by channel members (e.g., validated users accessing the environment using client devices) that are viewable only to the members of the group. The format of the group-based communication channel may appear differently to different members of the group-based communication channel; however, the content of the group-based communication channel (i.e., messaging communications), in some embodiments, will be displayed to each member of the group-based communication channel. For instance, a common set of group-based messaging communications may be displayed to each member of the respective group-based communication channel such that the content of the group-based communication channel (i.e., messaging communications) does not vary per member of the group-based communication channel.

The term “group-based communication interface” refers to a virtual communications environment (i.e., a specifically configured graphical user interface) configured to facilitate user interaction with a group-based communication platform. Each group-based communication interface is accessible and viewable to a select group of users (i.e., users that are associated with a selected group identifier), such as a group of employees of a business or organization (e.g., the Slack Corp. interface would be accessible and viewable to the Slack employees however the ACME Corporation group-based communication interface would not be accessible and viewable to Slack employees). The group-based communication interface includes a plurality of group-based communication channels (e.g., a marketing channel, sales channel, accounting channel, etc.).

As used herein, the terms “messaging communication” and “message” refer to any electronically generated digital content object provided by a user using a client device and that is configured for display within a group-based communication channel. Message communications may include any text, image, video, audio, or combination thereof provided by a user (using a client device). For instance, the user may provide a messaging communication that includes text as well as an image and a video within the messaging communication as message contents. In such a case, the text, image, and video would comprise the messaging communication or digital content object. Each message sent or posted to a group-based communication channel of the group-based communication system includes metadata comprising the following: a sending user identifier, a message identifier, message contents, a group identifier, and a group-based communication channel identifier. Each of the foregoing identifiers may comprise ASCII (American Standard Code for Information Interchange) text, a pointer, a memory address, and the like.

The terms “group-based communication channel identifier” or “channel identifier” refer to one or more items of data by which a group-based communication channel may be identified. For example, a group-based communication channel identifier may comprise ASCII text, a pointer, a memory address, and the like.

The terms “group identifier” or “team identifier” refer to one or more items of data by which a group within a group-based communication system may be identified. For example, a group identifier may comprise ASCII text, a pointer, a memory address, and the like.

A “sending user identifier” is associated with a collection of messages that are sent by a particular user (i.e., a client device associated with the particular user). These messages may be analyzed to determine context regarding the user (e.g., the user's expertise or interest in a topic may be determined based on the frequency of mention of the topic or key words associated with the topic within such messages).

Group-based communication system users are organized into organization groups (e.g., employees of each company may be a separate organization group) and each organization group may have one or more group-based communication channels (explained below) to which users may be assigned or which the users may join (e.g., group-based communication channels may represent departments, geographic locations such as offices, product lines, user interests, topics, issues, and/or the like). A group identifier may be used to facilitate access control for a message (e.g., access to the message, such as having the message return as part of search results in response to a search query, may be restricted to those users having the group identifier associated with their user profile). The group identifier may be used to determine context for the message (e.g., a description of the group, such as the name of an organization and/or a brief description of the organization, may be associated with the group identifier).

Group-based communication system users may join group-based communication channels. Some group-based communication channels may be globally accessible to those users having a particular organizational group identifier associated with their user profile (i.e., users who are members of the organization). Access to some group-based communication channels may be restricted to members of specified groups, whereby the group-based communication channels are accessible to those users having a particular group identifier associated with their user profile. The group-based communication channel identifier may be used to facilitate access control for a message (e.g., access to the message, such as having the message return as part of search results in response to a search query, may be restricted to those users having the group-based communication channel identifier associated with their user profile, or who have the ability to join the group-based communication channel). The group-based communication channel identifier may be used to determine context for the message (e.g., a description of the group-based communication channel, such as a description of a project discussed in the group-based communication channel, may be associated with the group-based communication channel identifier).

The term “private group-based communication channel” refers to a group-based communication channel with restricted access such that it is not generally accessible and/or searchable by other members of the group-based communication system. For example, only those users or administrators who have knowledge of and permission to access (e.g., a group-based communication channel identifier for the private group-based communication channel is associated with their user profile after the user has been validated/authenticated) the private group-based communication channel may view content of the private group-based communication channel.

### Overview

Various embodiments of the invention are directed to an improved apparatus that is configured to render a graphical sentiment and progression indicator to a messaging interface. The graphical sentiment and progression indicator is structured to combine a user sentiment (i.e., happy, sad, busy, overwhelmed) or other pictogram communication with a task progress indication.

In order to use a graphical sentiment and progression indicator, a user may type a specific input sequence indicating to his or her messaging application that he or she wishes to send a graphical sentiment and progression indicator, though some messaging applications also allow users to directly select a desired emoji component or emoticon of the graphical sentiment and progression indicator rather than typing in code points associated with the desired emoji component or emoticon. The messaging application parses the received input sequence identifying any code points and syntax elements. The messaging application then renders the graphical sentiment and progression indicator to the messaging interface based on the identified code points and the syntax element.

Users are adept at recognizing the sentiment conveyed by an emoji or emoticon and are able to draw conclusions about what the emoji or emoticon signifies. One drawback to emojis and emoticons, however, is that these pictorial representations are drawn from fixed set of images and are often bound to a developer's release schedule. As a result, a messaging interface of a messaging application may not be able to decode an input sequence comprising code points, emojis, or emoticons incompatible with the messaging application resulting in emoji display errors. Additionally, users of the messaging interface cannot easily customize the emojis or emoticons to express any sentiment beyond those already provided with their messaging application. That being said, the solutions that are embodied by the invention described herein provide a graphical sentiment and progression indicator that can convey information across a broad range of tasks associated with a user: driving to a destination, waiting to contact the user, participating in a meeting or activity, and the like.

An exemplary embodiment presents a mechanism for creating custom graphical sentiment and progression indicators that convey a task status that can be rendered on any device, regardless of the type of device, platform, operating system, and/or messaging application. The graphical sentiment and progression indicator is rendered based on code points and a syntax element of an input sequence.

In some embodiments, the graphical sentiment and progression indicator is accessible and viewable to a select group of users such as a group of employees of a business or organization. The graphical sentiment and progression indicator is rendered by a messaging application. The messaging application is configured to receive an input sequence comprising the code points and syntax element. The messaging application is then configured to transform the input sequence into a message format for rendering the graphical sentiment and progression indicator. The operations for transforming the input sequence may include processing and/or generating graphical expressions from the code points and the syntax element, which results in a more impactful message format form of the input sequence for providing information about the progress of the task.

The rendered graphical sentiment and progression indicator improves user experience by providing information on task completion via an easy to interpret emotive graphic. One of ordinary skill in the art will appreciate that the concepts discussed herein may be applied to better visualize messaging communications.

### Exemplary Architecture

Methods, apparatuses, and computer program products of the present invention may be embodied by any of a variety of devices. For example, the method, apparatus, and computer program product of an example embodiment may be embodied by a network device, such as a server or other network entity, configured to communicate with one or more devices, such as one or more client devices. In some preferred and non-limiting embodiments, the computing device may include fixed computing devices, such as a personal computer or a computer workstation. Still further, example embodiments may be embodied by any of a variety of mobile devices, such as a portable digital assistant (PDA), mobile phone, smartphone, laptop computer, tablet computer, wearable device, or any combination of the aforementioned devices.

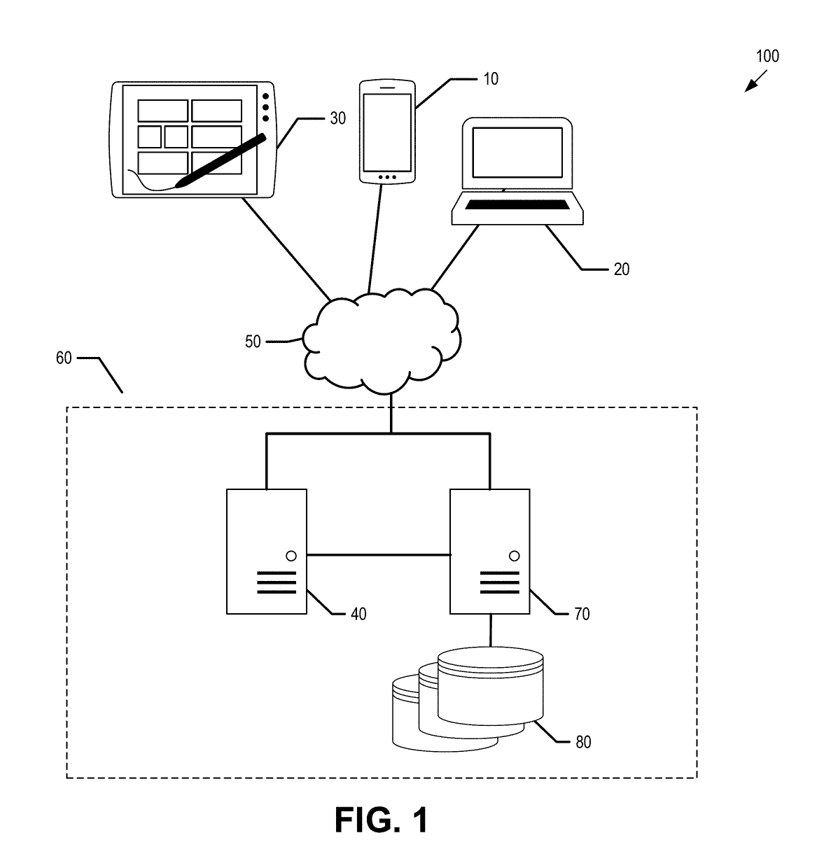

FIG. 1 shows system 100 including an example network architecture for a system, which may include one or more devices and sub-systems that are configured to implement some embodiments discussed herein. Users may access a group-based communication platform 60 via communication network 50 using one or more client devices 10-30. The group-based communication platform 60 may include a messaging application server 40 and a network application server 70.

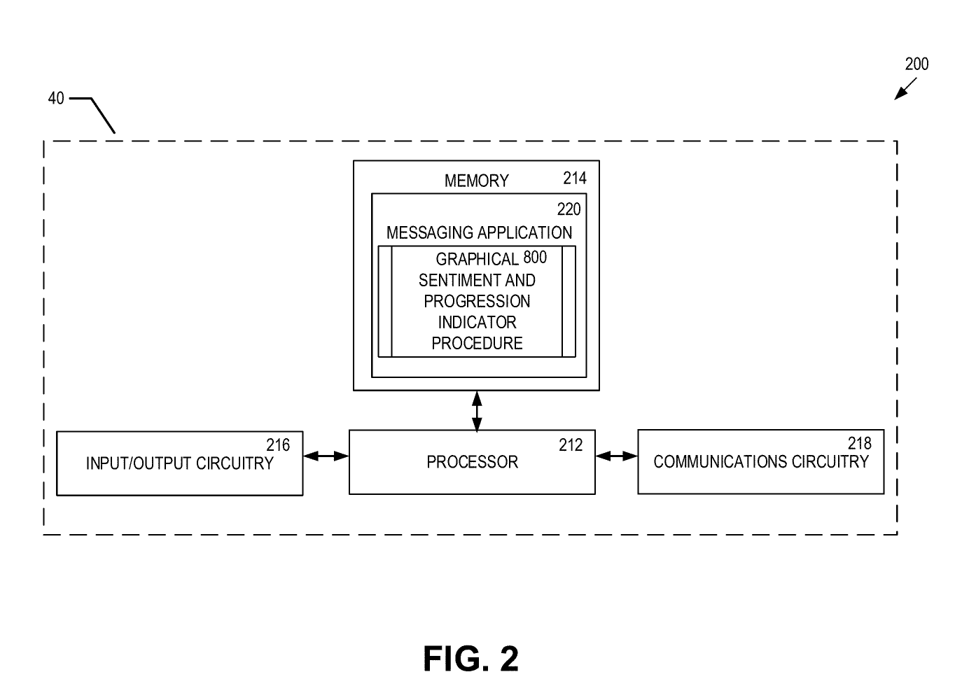

System 100 may include messaging application server 40, which can include, for example, the circuitry disclosed in FIG. 2. The messaging application server 40 may include any suitable network server and/or other type of processing device. Similarly, the messaging application server 40 may be embodied as a computer or computers as known in the art. The messaging application server 40 may provide for receiving electronic data from various sources, including, but not limited to, one or more client devices 10-30 via the communication network 50. For example, the messaging application server 40 may be operable to receive and process electronic messages provided by the client devices 10-30. The messaging application server 40 may also facilitate transmission and generation of electronic messages to the client devices 10-30.

In this regard, communication network 50 may include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, etc.). For example, communication network 50 may include a cellular telephone, an 802.11, 802.16, 802.20, and/or WiMax network. Further, the communication network 50 may include a public network, such as the Internet, a private network, such as an intranet, or combinations thereof, and may utilize a variety of networking protocols now available or later developed including, but not limited to TCP/IP based networking protocols. For instance, the networking protocol may be customized to suit the needs of the group-based communication interface. In some embodiments, the protocol is a custom protocol of JSON (JavaScript Object Notation) objects sent via a Web socket channel. In some embodiments, the protocol is JSON over RPC, JSON over REST/HTTP, and the like.

Similarly, the network application server 70 may be embodied as a computer or computers as known in the art. The network application server 70 may provide for receiving electronic data from various sources, including, but not limited to, the client devices 10-30 via the communication network 50. For example, the network application server 70 may be operable to receive and process electronic messages provided by the client devices 10-30. The network application server 70 may also be operable to receive and process network database queries provided by the client devices 10-30 and/or the messaging application server 40 regarding one or more databases 80. The network application server 70 may further facilitate the generation of user interfaces.

Client devices 10-30 and/or messaging application server 40 may each be implemented as a personal computer and/or other networked device, such as a cellular phone, tablet computer, mobile device etc., that may be used for any suitable purpose. The depiction in FIG. 1 of 10-30 client devices is merely for illustration purposes. Any number of client devices may be included in the system 100 so long as the users have the proper credentials for accessing the selected group-based communication interface. The one or more client devices may execute an “app” to interact with the messaging application server 40 and/or network application server 70. Such apps are typically designed to execute on mobile devices, such as smartphones or tablets. For example, an app may be provided that executes on mobile device operating systems such as Apple Inc.'s iOS®, Google Inc.'s Android®, or Microsoft Inc.'s Windows 10 Mobile®. These platforms typically provide frameworks that allow apps to communicate with one another, and with particular hardware and software components of mobile devices. For example, the mobile operating systems named above each provides frameworks for interacting with location services circuitry, wired and wireless network interfaces, user contacts, and other applications. Communication with hardware and software modules executing outside of the app is typically provided via application programming interfaces (APIs) provided by the mobile device operating system.

Additionally or alternatively, the client devices 10-30 may interact with the messaging application server 40 and/or network application server 70 via a web browser. The client devices 10-30 may also include various hardware or firmware designed to interact with the messaging application server 40 and/or network application server 70.

In some preferred and non-limiting embodiments, the one or more databases 80 may be embodied as a data storage device such as a network attached storage (NAS) device or devices, or as a separate database server or servers. The one or more databases 80 include information accessed and stored by the network application server 70. For example, the one or more databases 80 may include, without limitation, user profiles, user privilege information, electronic files, messaging communications organized among a plurality of group-based communication channels, and/or the like.

Additionally or alternatively, the client device 10-30 may interact with an exemplary group-based communication interface via a web browser. As yet another example, the client device 10-30 may include various hardware or firmware designed to interface with the group-based communication interface.

In some embodiments of an exemplary group-based communication system, a message or messaging communication may be sent from a client device 10-30 to a messaging application server 40. The messages may be sent to the group-based communication interface via an intermediary such as a messaging application server 40, and/or the like. For example, a client device 10-30 may be a desktop, a laptop, a tablet, a smartphone, and/or the like that is executing a messaging application (e.g., a group-based communication app). In one implementation, the message may include data such as a message identifier, sending user identifier, a group identifier, a group-based communication channel identifier, message contents (e.g., text, emojis, images, links), attachments (e.g., files), message hierarchy data (e.g., the message may be a reply to another message), third party metadata, and/or the like. In one embodiment, the client device 10-30 may provide the example message, substantially in the form of a (Secure) Hypertext Transfer Protocol (“HTTP(S)”) POST message including eXtensible Markup Language (“XML”) formatted data.

In some embodiments, a group identifier as defined above may be associated with the message. In some embodiments, a group-based communication channel identifier as defined above may be associated with the message.

In some embodiments, a sending user identifier as defined above may be associated with the message. In one implementation, the message may be parsed (e.g., using PHP (Hypertext Preprocessor) commands) to determine a sending user identifier of the user who sent the message.

In some embodiments, data indicating responses may be associated with the message. For example, responses to the message by other users may include reactions (e.g., selection of an emoji associated with the message, selection of a “like” button associated with the message), clicking on a hyperlink embedded in the message, replying to the message (e.g., posting a message to the group-based communication channel in response to the message), downloading a file associated with the message, sharing the message from one group-based communication channel to another group-based communication channel, pinning the message, starring the message, and/or the like.

In embodiments, the message may be parsed to determine whether to display an emoji component and a status indicator component with regards to the context of the user. (e.g., the user may be at the gym and should return in 30 minutes). An example of said custom messaging among the one or more client devices 10-30 is described below.

The messaging application server 40 may be embodied by one or more computing systems, such as rendering apparatus 200 shown in FIG. 2. Rendering apparatus 200 may be included in, for example, one or more client devices 10-30. Any of the aforementioned systems or devices may include the rendering apparatus 200 and may be configured to, either independently or jointly with other devices in a communication network 50 perform the functions of the rendering apparatus 200 described herein. As illustrated in FIG. 2, in accordance with some example embodiments, rendering apparatus 200 can includes various means, such as processor 212, memory 214, communications circuitry 218, and/or input/output circuitry 216. In some embodiments, messaging communications database and/or a channeling system may also or instead be included. As referred to herein, “circuitry,” or “interface” includes hardware, software and/or firmware configured to perform one or more particular functions. In this regard, the means of rendering apparatus 200 as described herein may be embodied as, for example, circuitry, hardware elements (e.g., a suitably programmed processor, combinational logic circuit, and/or the like), a computer program product comprising computer-readable program instructions stored on a non-transitory computer-readable medium (e.g., memory 214) that is executable by a suitably configured processing device (e.g., processor 212), or some combination thereof.

Processor 212 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 2 as a single processor, in some embodiments, processor 212 comprises a plurality of processors. The plurality of processors may be embodied on a single computing device or may be distributed across a plurality of computing devices collectively configured to function as rendering apparatus 200. The plurality of processors may be in operative communication with each other and may be collectively configured to perform one or more functionalities of rendering apparatus 200 as described herein. In an example embodiment, processor 212 is configured to execute instructions stored in memory 214 or otherwise accessible to processor 212. These instructions, when executed by processor 212, may cause rendering apparatus 200 to perform one or more of the functionalities of rendering apparatus 200 as described herein.

Whether configured by hardware, firmware/software methods, or by a combination thereof, processor 212 may comprise an entity capable of performing operations according to embodiments of the present invention while configured accordingly. Thus, for example, when processor 212 is embodied as an ASIC, FPGA or the like, processor 212 may comprise specifically configured hardware for conducting one or more operations described herein. Alternatively, as another example, when processor 212 is embodied as an executor of instructions, such as may be stored in memory 214, the instructions may specifically configure processor 212 to perform one or more algorithms and operations described herein, such as those discussed in connection with FIGS. 1-5.

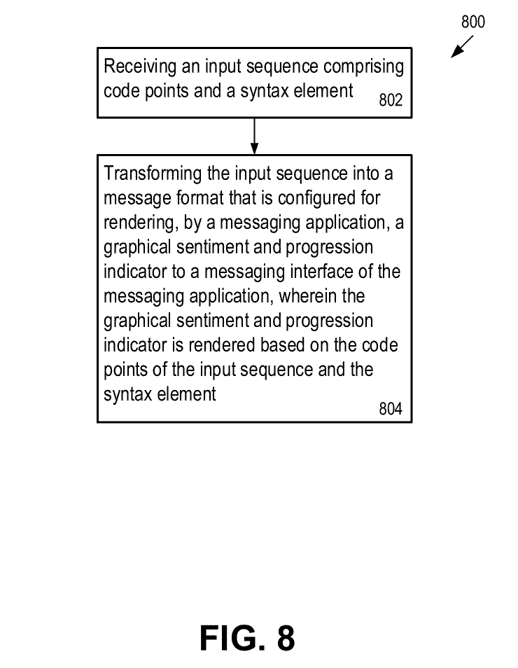

Memory 214 may comprise, for example, volatile memory, non-volatile memory, or some combination thereof. Although illustrated in FIG. 2 as a single memory, memory 214 may comprise a plurality of memory components. The plurality of memory components may be embodied on a single computing device or distributed across a plurality of computing devices. In various embodiments, memory 214 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. Memory 214 may be configured to store information, data (including item data and/or user account details), applications, instructions, or the like for enabling rendering apparatus 200 to carry out various functions in accordance with example embodiments of the present invention. For example, in at least some embodiments, memory 214 is configured to buffer input data for processing by processor 212. Additionally or alternatively, in at least some embodiments, memory 214 is configured to store program instructions for execution by processor 212. Memory 214 may store information in the form of static and/or dynamic information. This stored information may be stored and/or used by rendering apparatus 200 during the course of performing its functionalities. Memory 214 stores an exemplary messaging application 220. The messaging application 220 comprises program code for executing a graphical sentiment and progression indicator procedure 800 as illustrated in FIG. 8.

Communications circuitry 218 may be embodied as any device or means embodied in circuitry, hardware, a computer program product comprising computer readable program instructions stored on a computer readable medium (e.g., memory 214) and executed by a processing device (e.g., processor 212), or a combination thereof that is configured to receive and/or transmit data from/to another device and/or network, such as, for example, a second circuitry and/or the like. In some embodiments, communications circuitry 218 (like other components discussed herein) can be at least partially embodied as or otherwise controlled by processor 212. In this regard, communications circuitry 218 may be in communication with processor 212, such as via a bus. Communications circuitry 218 may include, for example, an antenna, a transmitter, a receiver, a transceiver, network interface card and/or supporting hardware and/or firmware/software for enabling communications with another computing device. Communications circuitry 218 may be configured to receive and/or transmit any data that may be stored by memory 214 using any protocol that may be used for communications between computing devices. Communications circuitry 218 may additionally or alternatively be in communication with the memory 214, input/output circuitry 216 and/or any other component of circuitry, such as via a bus.

Input/output circuitry 216 may be in communication with processor 212 to receive an indication of a user input and/or to provide an audible, visual, mechanical, or other output to a user (e.g., provider and/or consumer). As such, input/output circuitry 216 may include support, for example, for a keyboard, a mouse, a joystick, a display, a touch screen display, a microphone, a speaker, a RFID (Radio-frequency identification) reader, barcode reader, biometric scanner, and/or other input/output mechanisms. In embodiments wherein rendering apparatus 200 is embodied as a server or database, aspects of input/output circuitry 216 may be reduced as compared to embodiments where rendering apparatus 200 is implemented as an end-user machine (e.g., consumer device and/or provider device) or other type of device designed for complex user interactions. In some embodiments (like other components discussed herein), input/output circuitry 216 may even be eliminated from rendering apparatus 200. Alternatively, such as in embodiments wherein rendering apparatus 200 is embodied as a server or database, at least some aspects of input/output circuitry 216 may be embodied on an apparatus used by a user that is in communication with rendering apparatus 200. Input/output circuitry 216 may be in communication with the memory 214, communications circuitry 218, and/or any other component(s), such as via a bus. One or more than one input/output circuitry and/or other component can be included in rendering apparatus 200.

It is also noted that all or some of the information discussed herein can be based on data that is received, generated and/or maintained by one or more components of rendering apparatus 200. In some embodiments, one or more external systems (such as a remote cloud computing and/or data storage system) may also be leveraged to provide at least some of the functionality discussed herein.

As will be appreciated, any such computer program instructions and/or other type of code may be loaded onto a computer, processor or other programmable apparatus's circuitry to produce a machine, such that the computer, processor other programmable circuitry that execute the code on the machine create the means for implementing various functions, including those described herein.

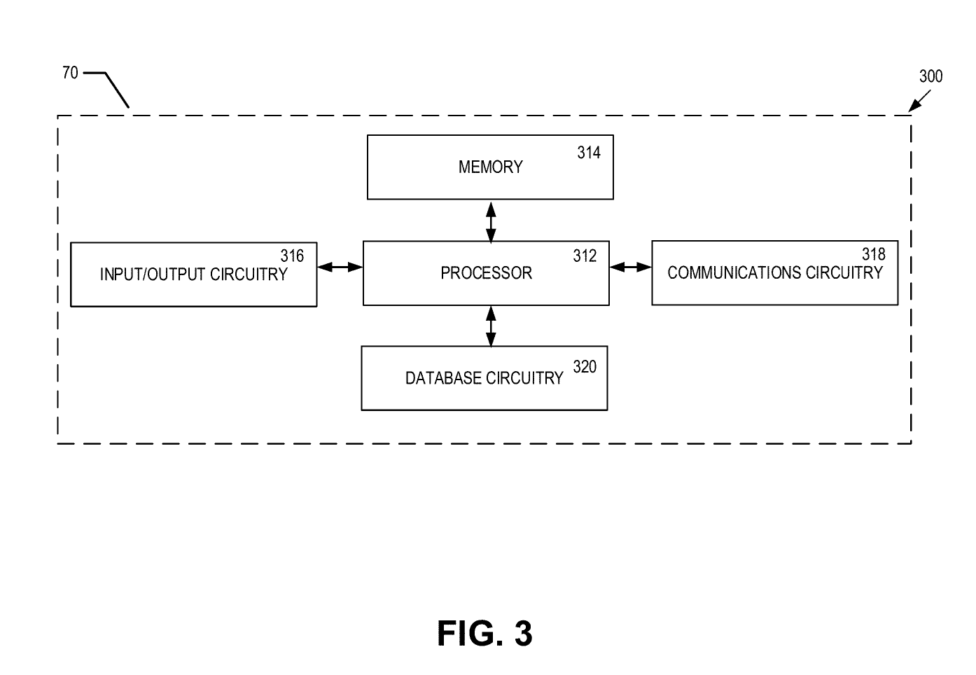

The network application server 70 may be embodied by one or more computing systems, such as apparatus 300 shown in FIG. 3. The apparatus 300 may include processor 312, memory 314, input/output circuitry 316, communications circuitry 318, and database circuitry 320. Although these components 312-320 are described with respect to functional limitations, it should be understood that the particular implementations necessarily include the use of particular hardware. It should also be understood that certain of these components 312-320 may include similar or common hardware. For example, two sets of circuitries may both leverage use of the same processor, network interface, storage medium, or the like to perform their associated functions, such that duplicate hardware is not required for each set of circuitries.

In some embodiments, the processor 312 (and/or co-processor or any other processing circuitry assisting or otherwise associated with the processor) may be in communication with the memory 314 via a bus for passing information among components of the apparatus. The memory 314 is non-transitory and may include, for example, one or more volatile and/or non-volatile memories. In other words, for example, the memory 314 may be an electronic storage device (e.g., a computer-readable storage medium). The memory 314 may be configured to store information, data, content, applications, instructions, or the like for enabling the apparatus 300 to carry out various functions in accordance with example embodiments of the present invention.

The processor 312 may be embodied in a number of different ways and may, for example, include one or more processing devices configured to perform independently. In some preferred and non-limiting embodiments, the processor 312 may include one or more processors configured in tandem via a bus to enable independent execution of instructions, pipelining, and/or multithreading.

In some preferred and non-limiting embodiments, the processor 312 may be configured to execute instructions stored in the memory 314 or otherwise accessible to the processor 312. In some preferred and non-limiting embodiments, the processor 312 may be configured to execute hard-coded functionalities. As such, whether configured by hardware or software methods, or by a combination thereof, the processor 312 may represent an entity (e.g., physically embodied in circuitry) capable of performing operations according to an embodiment of the present invention while configured accordingly. Alternatively, as another example, when the processor 312 is embodied as an executor of software instructions, the instructions may specifically configure the processor 312 to perform the algorithms and/or operations described herein when the instructions are executed.

In some embodiments, the apparatus 300 may include input/output circuitry 316 that may, in turn, be in communication with processor 312 to provide output to the user and, in some embodiments, to receive an indication of a user input. The input/output circuitry 316 may comprise a user interface and may include a display, and may comprise a web user interface, a mobile application, a client device, a kiosk, or the like. In some embodiments, the input/output circuitry 316 may also include a keyboard, a mouse, a joystick, a touch screen, touch areas, soft keys, a microphone, a speaker, or other input/output mechanisms.

The communications circuitry 318 may be any means such as a device or circuitry embodied in either hardware or a combination of hardware and software that is configured to receive and/or transmit data from/to a network and/or any other device, circuitry, or module in communication with the apparatus 300. In this regard, the communications circuitry 318 may include, for example, a network interface for enabling communications with a wired or wireless communication network. For example, the communications circuitry 318 may include one or more network interface cards, antennae, buses, switches, routers, modems, and supporting hardware and/or software, or any other device suitable for enabling communications via a network. Additionally or alternatively, the communications circuitry 318 may include the circuitry for interacting with the antenna/antennae to cause transmission of signals via the antenna/antennae or to handle receipt of signals received via the antenna/antennae.

Database circuitry 320 includes hardware configured to manage one or more network databases, including one or more databases 80. The database circuitry 320 may utilize processing circuitry, such as the processor 312, to perform these actions. In some embodiments, the database circuitry 320 may include a separate processor, specially configured Field Programmable Gate Array (FPGA), or Application Specific Integrated Circuit (ASIC). The database circuitry 320 may be implemented using hardware components of the apparatus configured by either hardware or software for implementing the functions described herein.

It is also noted that the apparatus 300 may further include an interface circuitry (not pictured) which includes hardware configured to generate group-based communication channel interfaces for client devices 10-30. The interface generation circuitry may utilize processing circuitry, such as the processor 312, to perform these actions. However, it should also be appreciated that, in some embodiments, the interface generation circuitry may include a separate processor, specially configured Field Programmable Gate Array (FPGA), or Application Specific Integrated Circuit (ASIC) for performing the functions described herein. The interface generation circuitry may be implemented using hardware components of the apparatus configured by either hardware or software for implementing these planned functions.

It is also noted that all or some of the information presented by the example displays discussed herein can be based on data that is received, generated and/or maintained by one or more components of a local or networked system and/or rendering apparatus 200. In some embodiments, one or more external systems (such as a remote cloud computing and/or data storage system) may also be leveraged to provide at least some of the functionality discussed herein.

As described above and as will be appreciated based on this disclosure, embodiments of the present invention may be configured as methods, personal computers, servers, mobile devices, backend network devices, and the like. Accordingly, embodiments may comprise various means including entirely of hardware or any combination of software and hardware. Furthermore, embodiments may take the form of a computer program product on at least one non-transitory computer-readable storage medium having computer-readable program instructions (e.g., computer software) embodied in the storage medium. Any suitable computer-readable storage medium may be utilized including non-transitory hard disks, CD-ROMs, flash memory, optical storage devices, or magnetic storage devices.

Embodiments of the present invention have been described herein with reference to block diagrams and flowchart illustrations of methods, apparatuses, systems and computer program products. It will be understood that each block of the circuit diagrams and process flowcharts, and combinations of blocks in the circuit diagrams and process flowcharts, respectively, can be implemented by various means including computer program instructions.

As will be appreciated, any such computer program instructions and/or other type of code may be loaded onto a computer, processor or other programmable apparatus's circuitry to produce a machine, such that the computer, processor or other programmable circuitry that execute the code on the machine creates the means for implementing various functions, including those described herein.

As described above and as will be appreciated based on this disclosure, embodiments of the present invention may be configured as methods, mobile devices, backend network devices, and the like. Accordingly, embodiments may comprise various means including entirely of hardware or any combination of software and hardware. Furthermore, embodiments may take the form of a computer program product on at least one non-transitory computer-readable storage medium having computer-readable program instructions (e.g., computer software) embodied in the storage medium. Any suitable computer-readable storage medium may be utilized including non-transitory hard disks, CD-ROMs, flash memory, optical storage devices, or magnetic storage devices.

Accordingly, blocks of the block diagrams and flowchart illustrations support combinations of means for performing the specified functions, combinations of steps for performing the specified functions and program instruction means for performing the specified functions. It will also be understood that each block of the circuit diagrams and process flowcharts, and combinations of blocks in the circuit diagrams and process flowcharts, can be implemented by special purpose hardware-based computer systems that perform the specified functions or steps, or combinations of special purpose hardware and computer instructions.

### Example Data Flows for Generating a Graphical Sentiment and Progression Indicator

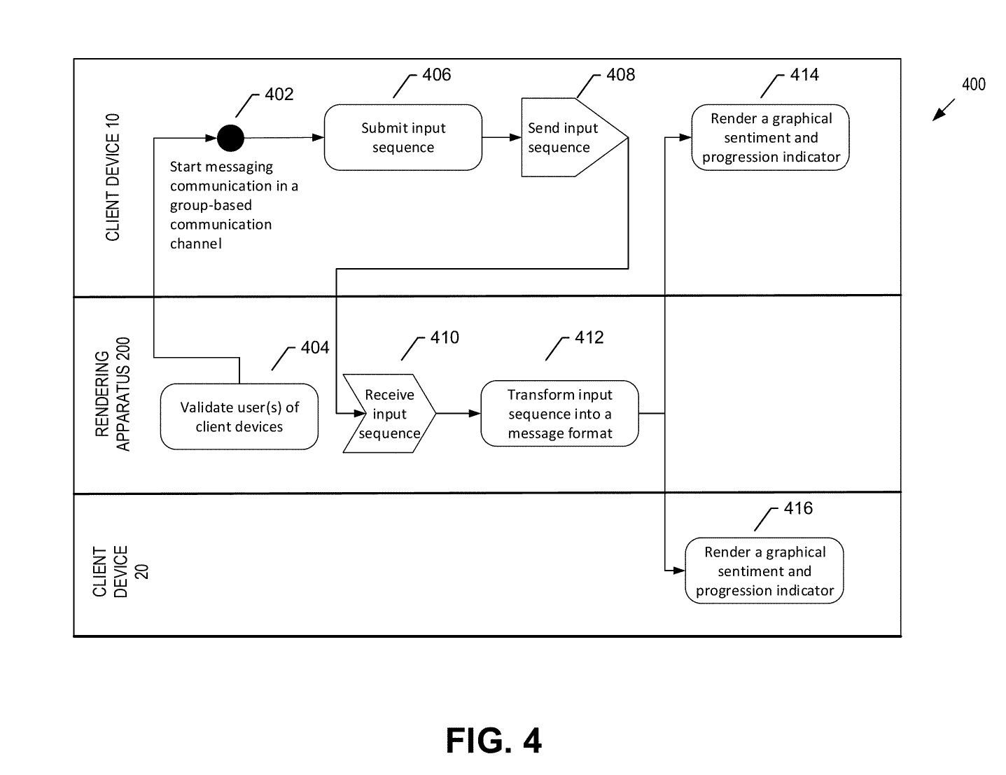

FIG. 4 illustrates various interactions between one or more client devices 10, 20, and rendering apparatus 200 in a group-based communication platform 60 (e.g. a cloud-based group collaboration tool provided by SLACK®) that is able to exchange data in real-time and render a graphical sentiment and progression indicator among client devices 10 and 20 through a group-based communication channel. In other words, members of organization X are able to view content and share data in the group-based communication channel.

In some embodiments of an exemplary group-based communication platform 60, a messaging communication may be sent from client device 10 to a group-based communication platform 60 (step 402) via rendering apparatus 200. In various implementations, messages may be sent to the group-based communication platform 60 over communication network 50 directly by one or more client devices 10-30. In such case, the users of the one or more client devices 10-30 are validated users (step 404) by a validation process implemented by rendering apparatus 200. In one implementation, the client device 10 submits a message which includes an input sequence comprising code points and a syntax element (step 406). In some embodiments, the input sequence may comprise an emoji or emoticon selected from a messaging interface menu and a syntax element. The syntax element comprises special command characters that indicate that a graphical sentiment and progression indicator be rendered. As shown in steps 408 and 410, the input sequence is automatically sent to and received by the rendering apparatus 200.

At step 412, the rendering apparatus 200 transforms the input sequence into a message format that is configured for rendering a graphical sentiment and progression indicator. The operation of transforming the data will be described in further detail below.

As shown in steps 414 and 416, the transformed data may be rendered by a messaging interface of client devices 10 and 20 to cause to display a graphical sentiment and a progression indicator.

In another embodiment, the message comprising the input sequence may further include identifier data such as a message identifier, sending user identifier, a group identifier, a group-based communication channel identifier, attachments (e.g., files), message hierarchy data (e.g., the message may be a reply to another message), third party metadata, and/or the like.

The group-based communication platform 60 comprising the messaging application server 40 and the network application server 70 may create a storage message based upon the message comprising the input sequence and the identifier data to facilitate message indexing and storage in the one or more databases 80. In one implementation, the storage message may include data such as a message identifier, a group identifier, a group-based communication channel identifier, a sending user identifier, topics, responses, message contents, attachments, message hierarchy data, third party metadata, conversation primitive data, and/or the like.

In some embodiments, a group identifier as defined above may be associated with the message. In some embodiments, a group-based communication channel identifier as defined above may be associated with the message.

In some embodiments, a sending user identifier as defined above may be associated with the message. In one implementation, the message may be parsed (e.g., using PHP commands) to determine a sending user identifier of the user who sent the message.

In some embodiments, a conversation primitive may be associated with the message. In one implementation, a conversation primitive is an element used to analyze, index, store, and/or the like messages. For example, the message may be analyzed by itself, and may form its own conversation primitive. In another example, the message may be analyzed along with other messages that make up a conversation, and the messages that make up the conversation may form a conversation primitive. In one implementation, the conversation primitive may be determined as the message, a specified number (e.g., two) of preceding messages and a specified number (e.g., two) of following messages.

In yet another embodiment, various metadata, as described above, and/or the contents of the message may be used to index the message (e.g., using the conversation primitive) to facilitate various facets of searching (i.e., search queries that return results from the messaging application server 40). The messaging application server 40 may query the network application server 70, which in turn identifies one or more client devices 10-30 associated with the group-based communication channel. The messaging application server 40 may further transmit the message to each identified client device.

In one implementation, metadata associated with the message may be determined and the message may be indexed in the messaging application server 40. In one embodiment, the message may be indexed such that a company's or a group's messages are indexed separately (e.g., in a separate index associated with the group and/or company that is not shared with other groups and/or companies). In one implementation, messages may be indexed at a separate distributed repository (e.g., to facilitate data isolation for security purposes).

### Example Implementation for Generating a Graphical Sentiment and Progression Indicator

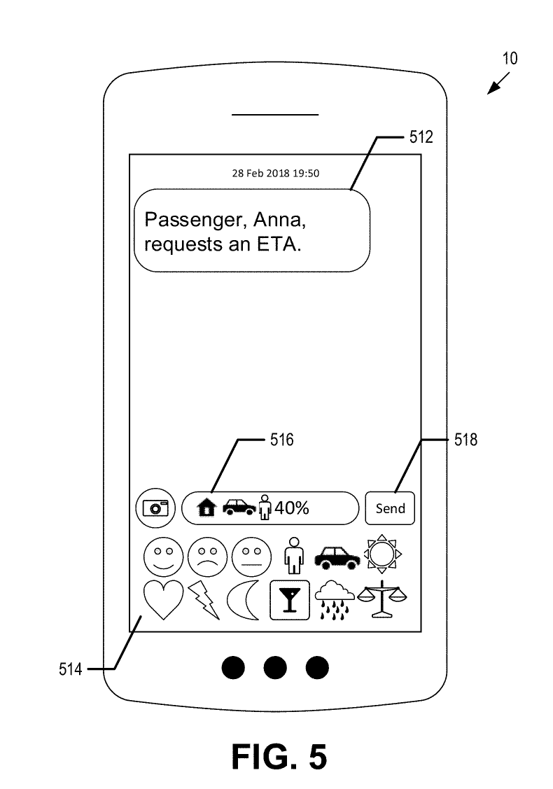

FIG. 5 illustrates an example messaging interface of messaging application 220 of rendering apparatus 200 structured in accordance with various embodiments of the invention. FIG. 5 depicts the messaging interface for sending a message in accordance with the present disclosure. Sender George is a user operating client device 10 that is running a messaging application such as messaging application 220. Client device 10 may execute an “app” to interact with the messaging application server 40 and/or the network application server 70. The messaging application server 40 may be embodied by rendering apparatus 200 shown in FIG. 2. In an example embodiment, rendering apparatus 200 may be included in, for example, client device 10.

As shown in FIG. 2, the client device 10 having messaging application 220 causes to display a message from a user Anna operating client device 20. The message from client device 20 requests an estimated time of arrival as shown in message 512. In response, the messaging application 220 provides an input field to which user George can send a response. Client device 10 comprises an input sequence 516. The input sequence 516 includes alphanumeric characters and a emoji or emoticon. The emoji or emoticon may be provided via a keyboard display area provided in the messaging interface of messaging application 220, which may include menu comprising a plurality of emojis or emoticons as depicted in 514. The messaging application 220 provides a send button 518 to process the input sequence for rendering a graphical sentiment and progression indicator that dynamically reflects the status of user George's task of driving to pick up user Anna to a messaging interface of messaging application 220 according to the graphical sentiment and progression indicator procedure 800.

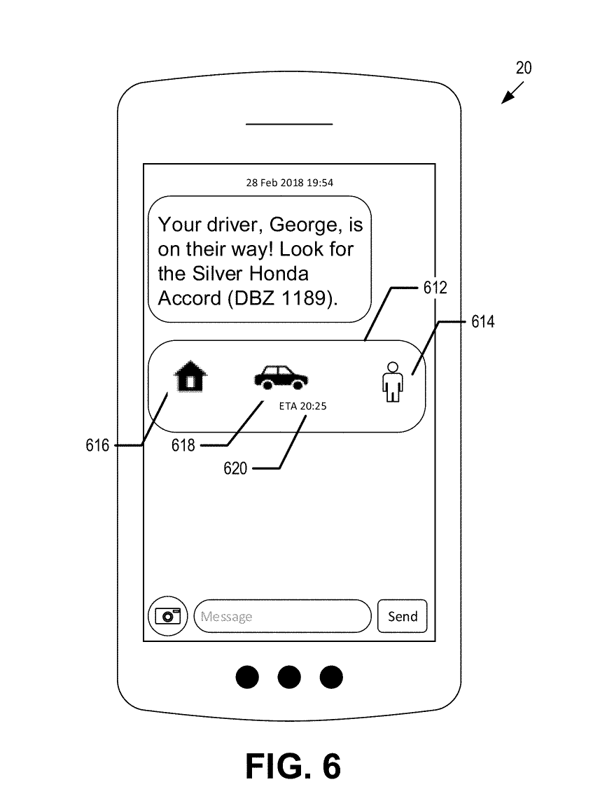

FIG. 6 illustrates the rendered graphical sentiment and progression indicator on client device 20. Client device 20 may be embodied by rendering apparatus 200 or may execute an “app” to interact with the messaging application 220 of messaging application server 40. The message 612 of client device 20 includes a graphical sentiment and progression indicator. In accordance with the normal operation of a messaging interface, the graphical sentiment and progression indicator is displayed in-line in the messaging interface of messaging application 220, showing the emojis or emoticons in sequence.

In the depicted embodiment, client device 20 renders message 612, which consists of an emoji component comprising emoji 616, emoji 614, and emoji 618. The text 620 is also shown in message 612. Messaging application 220 renders the graphical sentiment and progression indicator to the messaging interface, the emoji 618 represents a progress point progressing from emoji 616 towards emoji 614 (e.g. traveling from point A from point B) with the position of the progress point representing a percentage of the driving task already completed. In certain embodiments, the emoji 618 first appears as starting from emoji 616 (e.g., start point) and appears to move towards emoji 614 (e.g., end point) as the vehicle approaches client device 20's location, the progress point progressively moves closer to emoji 614. As such, user Anna can quickly interpret user George's status with regards to the task of picking her up by the graphical sentiment and progression indicator shown in message 612.

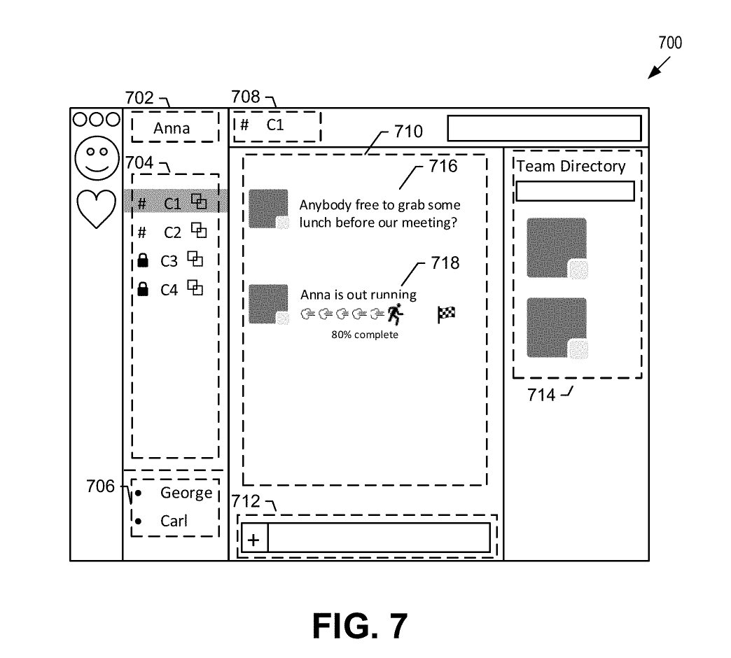

Referring now to FIG. 7, an example group-based communication interface 700 is shown. The group-based communication interface 700 includes a user name box 702, indicating the current user account associated with the group-based communication interface 700.

The depicted group-based communication interface 700 includes a list pane 704, which allows a user to quickly and easily navigate between all group-based communication channels that the user has access to. For example, as shown in FIG. 7, the user Anna has subscribed to group-based communication channels C1, C2, C3, and C4, which are indicated by an overlapping square symbol to the right of each group-based communication channel name. Each group may set its preference as to the name of a group-based communication channel in the list pane 704. The group-based communication channels in the list pane 704 are shared with other users with the same group or organization.

The status of the group-based communication channel may be indicated by an icon to the left of the group-based communication channel name. For example, as shown in subpane 704 of FIG. 7, group-based communication channels C1 and C2 each has a pound sign next to its name, which indicates that they are public group-based communication channels; group-based communication channels C3 and C4 each has a lock sign next to its name, which indicates that they are private group-based communication channels.

The group-based communication interface 700 further includes a group-based communication channel title box 708 and a direct message pane 706. The direct message pane 706 lists all the members who share the same group-based communication channel as the user. For example, as shown in the direct message pane 706 of FIG. 7, the user may send a direct message to George or Carl, who share the same group-based communication channel C1 as the user. In connection with the direct message pane 706, the group-based communication interface 700 may further include a flexpane 714, which may display information such as member directory of a group. The member directory may be browseable, searchable, and filterable through the flexpane 714.

A user may use the group-based communication channel input box 712 to contribute to the group-based communication channel, which would be displayed in the group-based communication channel messaging pane 710. The group-based communication channel messaging pane 710 comprises text, images, and other history data associated with the group-based communication channel. The group-based communication channel input box 712 may provide an autocomplete function, which automatically recognizes user name, group-based communication channel name, and other information as a user types in the group-based communication channel input box 712. In some embodiments, the auto-complete function may also recognize code points and syntax elements. For example, as a user enters code points or syntax elements, the group-based communication channel input box 712 may display, via a hover display message, the desired corresponding graphical sentiment and progression indicator which is rendered and shown for display as message 718 in response to message 716.

FIG. 8 illustrates a flow diagram for the graphical sentiment and progression indicator procedure 800 with some embodiments discussed herein. The graphical sentiment and progression indicator procedure 800 illustrated in FIG. 8 includes receiving an input sequence comprising code points and a syntax element 802. In some examples, the sequence employs a syntax in which the code points placed before a numeric character and percentage syntax element (e.g., “90%”) indicates generation of a graphical sentiment and progression indicator. For example, as shown in FIG. 5, input sequence 516 contains numeric characters and percentage syntax element and three emojis, the rendering apparatus 200 is configured to transform the input sequence into a message format that is configured for rendering by a messaging application such as messaging application 220 as shown in block 804. The rendering apparatus 200 is configured to generate a message format that is configured for rendering, by a message application, a graphical sentiment and progression indicator to a messaging interface of the messaging application 220 as shown in message 612 in FIG. 6 and message 718 in FIG. 7.

In some embodiments, the rendering apparatus 200 is configured to transform the input sequence into a message format configured to render the graphical sentiment and progression indicator by parsing the input sequence of characters, comparing them against code points to generate an emoji component comprising one or more emojis or emoticons. The format of emojis or emoticons may appear differently or not at all on client devices equipped with different operating systems; however, the rendering apparatus 200 may be configured to replace any instance of a graphical sentiment and progression indicator so as to render compatible with any operating system of a messaging application. For example, the rendering apparatus 200, using a suitable code conversion reference table, may convert one or more code points from the input sequence to one or more code points that are not exactly equivalent to the requested emoji component but have a graphical appearance that is similar. The code conversion reference table may be loaded in memory 214 in the rendering apparatus 200. The code conversion table is processed with the graphical sentiment and progression indicator procedure 800. In the instance when the rendering apparatus 200 encounters a Unicode character, byte, or other data unit that has no mapping in the target rendering or encoding or that is otherwise unknown or invalid, the code conversion table makes use of substitute, fallback emojis or emoticons mappings and sends the substitute, fallback mapping result back to the graphical sentiment and progression indicator procedure 800, which then inserts the substitute, fallback emojis or emoticons to the message format.

The rendering apparatus 200 further identifies the syntax element that call to transform the input sequence into a message format. The rendering apparatus 200 calls to the graphical sentiment and progression indicator procedure 800 for transforming the input sequence into the message format configured for rendering the graphical sentiment and progression indicator. Example pseudocode for said call is shown below:

// Pseudocode for GraphicalSentimentProgressionIndicator class that
allows for the definition
// of three properties - a graphical representation for ″start point″,
// “progress point”, and an ″end point″
A standard progress bar may be defined as new ProgressBar(‘[:bar]’, {
complete: ‘=’,
incomplete: ‘ ’,
head: ‘>’
});
// This would result in [===========> ] 54%
// Now, let's think about how a graphical sentiment and progression
indicator is composed. Let's
// take “house” as an example.
//
// That's composed as:
// [symbol] U+1F3E0
// and “car” that's composed as
// [symbol] U+1F697
// Now, add ZWJ (Zero Width Joiner) control sequence,
// specifically a directional instruction.
//
// That would result in the same car as above, but facing right.
//
// [symbol] U+1F697// U+200D Zero Width Joiner
// U+27A1 Right Arrow
// Combine that with “person” that's composed of [symbol] U+1F469
// Use all in our GraphicalSentimentProgressionIndicator
// class to come up with a ″pretty progress bar″
new GraphicalSentimentProgressionIndicator (‘:bar’, {
start point: ‘\1f3e0’,
progress point: ‘\u1f697\u200d\u27a1\u200d1\ufe0f’,
end point: \u1f469’
});

As shown above, the message format that is configured via the graphical sentiment and progression indicator procedure 800 comprises a start point, a progress point, and an end point, wherein the progress point is configured to progress from the start point that indicates a beginning of a task to the end point that indicates an end of the task, whereby the progress of the progress point from the start point to the end point graphically indicates a percentage measurement of the task completed. The percentage measurement may be determined by the numeric character and percentage syntax element (e.g., “90%”). The rendering apparatus 200 is configured to progress the progress point based on the syntax element.

The call suitably sets the width style value that corresponds to the progress of the progress point from the start point that indicates a beginning of task to the end point that indicates an end of the task. The graphical sentiment and progression indicator is configured to dynamically reflect a task. In some example embodiments, dynamically reflecting a task includes a change in a portion of the graphical sentiment and progression indicator. Accordingly, the graphical sentiment and progression indicator provides a visual representation corresponding to a percentage of the task that has been completed.

In some cases, operations needed to complete the task are based on a determination of activity level measurement performed by a user of the messaging interface. In an example embodiment, the activity level measurement is compared with an activity level measurement threshold. If the activity level measurement is less than an activity level measurement threshold, then the graphical sentiment and progression indicator does not indicate a visual change in appearance. If the measured activity level measurement is greater than or equal to the activity level measurement threshold, the graphical sentiment and progression indicator is filled by the amount corresponding to the activity level measurement.

For example, the rendering apparatus 200 may request for activity data from navigation applications or fitness monitoring applications that run on a client device or any other applications related to time management (e.g., calendars, meetings, time accounting) that may provide user tracking or user context data. According to one example embodiment, the graphical sentiment and progression indicator may be set based on the current availability status of a user's corresponding calendar application. For example, if the calendar application indicates an event from 9:00-9:30 AM on Monday, and the current time is 9:15 AM on Monday, then the progress point of the graphical sentiment and progression indicator may be set to halfway from the start point to the end point indicating the meeting is only halfway complete. Thus, in addition to informing a potential caller that the user is currently busy, the graphical sentiment and progression indicator may indicate to the caller to message or call the user after 15 more minutes. In such example, the rendering apparatus 200 may parse items in the calendar to identify events such as meetings to obtain meeting information. In general, the obtained meeting information includes data such as start time, end time, date, and location.

The rendering apparatus 200 then uses the data in the message format that is configured for rendering the graphical sentiment and progression indicator by setting the start point to the start time of the meeting, the end point to the end point of the meeting, and the progress point that is configured to progress from the start point to the end point is set to the current time of the client device having the calendar application. In certain embodiments, the rendering apparatus 200 may include a calendar emoji in the message format and a syntax element for a circular progress bar so what appears to be rendered is a graphical sentiment and progression indicator having an animated circular progress bar with an emoji calendar inside it.

Additionally or alternatively, the graphical sentiment and progression indicator is then converted into an image file including the JPEG, GIF, or PNG standards for rendering. Suitably then, the image file comprising the graphical sentiment and progression indicator is available to be rendered with any messaging interface, regardless of the type of device, platform, or operating system used. Thus, the conversion into the image file may avoid a situation in which a messaging application may not be able to decode an input sequence comprising code points, emojis, or emoticons incompatible with the messaging application resulting in emoji display errors.

In yet another example embodiment, the graphical sentiment and progression indicator, which, when rendered is configured to animate the progress point such that the progress point appears to move from the start point towards the end point. The movement may be horizontal or circular. In this case, the message format that is configured for rendering the graphical sentiment and the progression indicator may include a progress awareness indicator rendered proximate to the progress point such that, when rendered in combination, indicates motion. For example, a “dash” or “gust of air” emoji may be used as a progress awareness indicator in combination with another emoji such as a “runner” or “car” to represent fast movement of a person or object. See, for example, the graphical sentiment and progression indicator which is rendered and shown for display as message 718 of FIG. 7. In such embodiment, the rendering apparatus 200 calls to the graphical sentiment and progression indicator procedure 800 for transforming the input sequence into the message format configured for rendering the graphical sentiment and progression indicator. Example pseudocode for said call is shown below:

// Pseudocode for GraphicalSentimentProgressionIndicator class that
allows for the definition
// of three properties - a graphical representation for “start point”,
// “progress point”, and an “end point”
A standard progress bar may be defined as new ProgressBar(‘[:bar]’, {
complete: ‘=’,
incomplete: ‘ ’,
head: ‘>’
});
// This would result in [===========> ] 54%
// Now, let's think about how a graphical sentiment and progression
indicator is composed. Let's
// take “Woman Running: Dark Skin Tone” as an example.
//
// That's composed as:
// [symbol] U+1F3C3 Person Running
// □ U+1F3FF Dark Skin Tone
// U+200D Zero Width Joiner
// ♀ U+2640 Female
// Now, add ZWJ (Zero Width Joiner) control sequence,
// specifically a directional instruction.
//
// That would result in the same runner as above, but facing right.
//
// [symbol] U+1F3C3 Person Running
// □ U+1F3FF Dark Skin Tone
// U+200D Zero Width Joiner
// [symbol] U+2640 Female
// U+200D Zero Width Joiner
// U+27A1 Right Arrow
// Combine that with [symbol] (Dashing Away) and use the same ZWJ sequence
to also turn it to the right. Additionally, use the [symbol] (Checkered Flag) to
indicate the end of the task
// Use all in our GraphicalSentimentProgressionIndicator
// class to come up with a “pretty progress bar”
new GraphicalSentimentProgressionIndicator (‘:bar’, {
complete: ‘\ud83d\udca8\udca8\u27a1’,
incomplete: ‘ ’,
progress point: ‘\ud83c\udfc3\ud83c\udfff\u200d\u2640\u200d\u27a1’
end point: ‘\u1f3c1’
});

As shown above, the message format that is configured via the graphical sentiment and progression indicator procedure 800 comprises the following properties: complete, incomplete, progress point, and end point, wherein the complete property indicates progress from the start point that indicates a beginning of a task to the end point that indicates an end of the task. The incomplete property indicates the progress left for the task to be completed. The rendering apparatus 200 is configured to animate the progress point such that the progress point appears to move from the start point towards the end point according to the syntax element. In some example embodiments, the rendering apparatus 200 generates a series of output frames comprising the progress awareness indicator and combines with the progress point into an animated GIF image. Suitably then, the GIF file comprising the graphical sentiment and progression indicator is available to be rendered with any messaging interface, regardless of the type of device, platform, or operating system used.

In yet another example embodiment, the rendering apparatus 200 transforms the data from the input sequence into a message format that is configured for rendering a graphical sentiment comprising an emoji component and a progression indicator comprising a status indicator component. The status indicator component may depict a progress bar that is being dynamically filled and indicates a percentage of a task already completed. In certain embodiments and in light of the George and Anna example, the progress bar first appears as an empty vertical rectangle when George's vehicle is a predetermined time (e.g., 10 seconds) or distance (e.g., 100 meters) from Anna's location. As the vehicle approaches Anna's location, the progress bar progressively “fills in.” The “filling in” is indicated by a change of color, i.e., the “empty” progress bar progressively becomes “full.”

In some embodiments, the rendering apparatus 200 further identifies syntax elements that call to a status indicator object structure. In generating a status indicator component to be rendered to a messaging interface, such as a progress bar element, a traffic light element, a tachometer element, an infographic element, a pie bar element, an hourglass element, or a timer element, the rendering apparatus 200 calls to the status indicator object structure for one or more of the status indicator objects.

Preferably, the syntax element suitably indicates to the status indicator object structure which type of status indicator is needed. For example, an address within memory 214 for the status indicator component is provided to allocate memory for an indicator type by the indicator object. The rendering apparatus 200 analyzes the syntax element using syntax-directed translations to identify special command characters used to call for the desired status indicator object. In one embodiment, the status indicator object may be indicated by syntax element (e.g., “:bar”: progress bar element; “:cirbar”: circular progress bar element; “:traffic”: traffic light element; “:tacho”: tachometer element; “:infograph”: infographic element; “:pie”: pie bar element; “:hourglass”: hourglass element; “:timer”: timer element). The desired indicator object, including the code point data are then encapsulated by the appropriate subclass of status indicator objects to be converted into an image file including the JPEG, GIF, or PNG standards for rendering. Suitably then, the image file comprising the graphical sentiment and progression indicator is available to be rendered with any messaging interface, regardless of the type of device, platform, or operating system used.

Additional syntax and/or code points may also be useful for specifying parameters associated with the graphical sentiment and progression indicator. For example and as shown above, a joiner Unicode character code point ZWJ (Zero Width Joiner) may be used to join two or more emojis or emoticons together in a sequence to create an emoji glyph as part of the graphical sentiment and the progression indicator (e.g., female emoji with brown hair). In yet another example, a direction Unicode character code point specifies an orientation (e.g., right facing or left facing) of the graphical sentiment and progression indicator.

The messaging application 220 is configured to render the graphical sentiment and progression indicator to the messaging interface of messaging application 220, wherein the graphical sentiment and the progression indicator is rendered based on the syntax element, and is configured to dynamically reflect a task status. In some example embodiments, the graphical sentiment and the progression indicator conveys progress information in a more engaging way than simply displaying numbers. In another example embodiment, the graphical sentiment and the progression indicator comprises a recognizable progress bar. Other types of status indicator elements which changes size and/or shape to depict the progression of the task can be employed within the context of the invention as well. Examples of such include a “pie-chart” type of indicator, an hourglass-type of indicator, and the like. In certain embodiments, the graphical sentiment and the progression indicator may provide accompanying text or annotation describing the context of the graphical sentiment and progression indicator as shown by text 620 in FIG. 6.

Beyond the types of graphical sentiment and progression indicators described above, animations may be desirable to supplement the graphical sentiment and progression indicator. For example, animations may alert users when a task is complete. By specifying certain code points or syntax elements to indicate these animations, other embodiments could easily incorporate these types of features. Animations may include specifying different colors or altering the size of the graphical sentiment and progression indicator.

Many modifications and other embodiments of the inventions set forth herein will come to mind to one skilled in the art to which these embodiments of the invention pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. An apparatus comprising:
at least one processor; and
at least one memory including computer program code for one or more programs,
the at least one memory and the computer program code configured to, with the at least one processor, cause the apparatus to perform at least the following:
receive an input sequence comprising code points and a syntax element; and
transform the input sequence into a message format that is configured for rendering, by a messaging application, a graphical sentiment and progression indicator to a messaging interface of the messaging application, wherein the graphical sentiment and progression indicator is rendered based on the code points and the syntax element of the input sequence.

2. The apparatus of claim 1, wherein the message format that is configured for rendering the graphical sentiment and progression indicator further comprises a start point, a progress point, and an end point, wherein the progress point is configured to progress from the start point that indicates a beginning of a task to the end point that indicates an end of the task, whereby the progress of the progress point from the start point to the end point graphically indicates a percentage measurement of the task completed.

3. The apparatus of claim 2, wherein operations to complete the task is based on a determination of an activity level measurement performed by a user of the messaging interface.

4. The apparatus of claim 2, wherein the at least one memory and the computer program code are further configured to, with the at least one processor, cause the apparatus to progress the progress point based on the syntax element.

5. The apparatus of claim 4, wherein the graphical sentiment and progression indicator, which, when rendered, is configured to animate the progress point such that the progress point appears to move from the start point towards the end point.

6. The apparatus of claim 5, wherein the message format that is configured for rendering the graphical sentiment and progression indicator further comprises a progress awareness indicator rendered proximate to the progress point such that, when rendered in combination, indicates motion.

7. The apparatus of claim 1, wherein transforming the input sequence into the message format that is configured for rendering the graphical sentiment and progression indicator further comprises providing a joiner Unicode character configured to join two or more emojis or emoticons together in sequence to create a glyph.

8. The apparatus of claim 1, wherein transforming the input sequence into the message format that is configured for rendering the graphical sentiment and progression indicator further comprises providing a direction Unicode character configured to specify direction of an emoji or emoticon.

9. The apparatus of claim 1, wherein the message format that is configured for rendering the graphical sentiment and progression indicator further comprises an emoji component determined via an emoji component menu on the messaging interface of the messaging application.

10. A method comprising:
receiving an input sequence comprising code points and a syntax element; and
transforming the input sequence into a message format that is configured for rendering, by a messaging application, a graphical sentiment and progression indicator to a messaging interface of the messaging application, wherein the graphical sentiment and progression indicator is rendered based on the code points and the syntax element of the input sequence.

11. The method of claim 10, wherein the message format that is configured for rendering the graphical sentiment and progression indicator further comprises a start point, a progress point, and an end point, wherein the progress point is configured to progress from the start point that indicates a beginning of a task to the end point that indicates an end of the task, whereby the progress of the progress point from the start point to the end point graphically indicates a percentage measurement of the task completed.

12. The method of claim 11, wherein operations to complete the task is based on a determination of an activity level measurement performed by a user of the messaging interface.

13. The method of claim 11, wherein the at least one memory and the computer program code are further configured to, with the at least one processor, cause the apparatus to progress the progress point based on the syntax element.

14. The method of claim 13, wherein the graphical sentiment and progression indicator, which, when rendered, is configured to animate the progress point such that the progress point appears to move from the start point towards the end point.

15. The method of claim 14, wherein the message format that is configured for rendering the graphical sentiment and progression indicator further comprises a progress awareness indicator rendered proximate to the progress point such that, when rendered in combination, indicates motion.

16. The method of claim 10, wherein transforming the input sequence into the message format that is configured for rendering the graphical sentiment and progression indicator further comprises providing a joiner Unicode character configured to join two or more emojis or emoticons together in sequence to create a glyph.

17. The method of claim 10, wherein transforming the input sequence into the message format that is configured for rendering the graphical sentiment and progression indicator further comprises providing a direction Unicode character configured to specify direction of an emoji or emoticon.

18. The method of claim 10, wherein the message format that is configured for rendering the graphical sentiment and progression indicator further comprises an emoji component determined via an emoji component menu on the messaging interface of the messaging application.

19. A computer program product comprising:
at least one computer readable non-transitory memory medium having program code instructions stored thereon, the program code instructions which when executed by an apparatus causes the apparatus at least to:
receive an input sequence comprising code points and a syntax element; and
transform the input sequence into a message format that is configured for rendering, by a messaging application, a graphical sentiment and progression indicator to a messaging interface of the messaging application, wherein the graphical sentiment and progression indicator is rendered based on the code points and the syntax element of the input sequence.

20. The computer program product of claim 19, wherein the message format that is configured for rendering the graphical sentiment and progression indicator further comprises a start point, a progress point, and an end point, wherein the progress point is configured to progress from the start point that indicates a beginning of a task to the end point that indicates an end of the task, whereby the progress of the progress point from the start point to the end point graphically indicates a percentage measurement of the task completed.
